(19) United States
(12) Patent Application Publication
(10) Pub. No.: US 2006/0187025 A1
(43) Pub. Date: Aug. 24, 2006

(54) Mobile communication device with user wellness verification

(76) Inventors: G Eric Engstrom, Kirkland, WA (US); Margaret P. Waggoner, Scottsdale, AZ (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/551,253

(22) PCT Filed: Apr. 1, 2004
(86) PCT No.: PCT/US04/09987

§ 371 Date: Sep. 28, 2005

Related U.S. Application Data
(60) Provisional application No. 60/459,875, filed on Apr. 1, 2003.

(51) Int. Cl. G08B 1/08

(52) U.S. Cl. 340/539.12

(57) ABSTRACT

A mobile communication device is equipped with one or more components to report on one or more events, and logic to identifying one of more user wellness verification conditions based at least in part on the reporting or the absence of the reporting. The logic is further equipped to solicit user interactions with the device to verify the user's wellness, when a wellness verification condition is identified. In various embodiments, the mobile communication device is further equipped to report, on failure of the user to satisfactorily interact when solicited, the failure. In various embodiments, the components contributing to the event reporting, and/or the logic that at least contribute to the receipt of the event reporting, identification of the verification conditions, soliciting the user interactions, and reporting the failures, may be embedded in whole or in part on an interchangeable cover of the mobile communication device.

### RELATED APPLICATION

This application is non-provisional application of Provisional Application No. 60/459,875, filed on Apr. 1, 2003, having the same title, and claim priority to said '875 provisional application.

Said '875 provisional application is a continuation-in-part application, claiming priority to:

(a) U.S. patent application Ser. No. 10/087,098, filed 3/1/2002, entitled “PERSONALIZING ELECTRONIC DEVICES AND SMART COVERING”, which itself claims priority to its provisional filing No. 60/306,326, on 7/17/2001; and

(b) U.S. patent application Ser. No. 09/932,154, filed 8/17/2001, entitled “MOBILE ELECTRONIC DEVICE AND COVERING FOR SIMILAR DEVICES WITH ORNAMENT ATTACHMENT MECHANISM”, which itself claims priority to its provisional filing No. 60/292,123, on 5/17/2001.

Accordingly, the U.S. version of this application further claims priority, through the '875 provisional application, to the '098 and '154 non-provisional applications, and to their parent applications, the '326 and the '123 provisional applications, for the materials described in the respective non-provisional and provisional applications.

Additionally, the U.S. version of this application further claims priority to U.S. application Ser. No. 09/908,118, filed Jul. 17, 2001, entitled “LUMINESCENT SIGNALING DISPLAYS UTILIZING A WIRELESS MOBILE COMMUNICATION DEVICE”.

### FIELD OF THE INVENTION

The present invention relates to the field of mobile communication devices. More specifically, the present invention is related to mobile communication devices, such as wireless mobile phones, personal digital assistants (PDA) and so forth, equipped with user wellness verification capabilities.

### BACKGROUND OF THE INVENTION

Advances in microprocessor and telecommunication technology have led to wide spread deployment and adoption of mobile devices, such as wireless mobile phones and PDA. For wireless mobile phones, in addition to wireless telephony, the late models are often equipped with advanced capabilities, such as calendar, address book, access to the World Wide Web (WWW), emails, and so forth. Similarly, for PDA, in addition to calendar and address book functions, the late models are often equipped with advanced capabilities, such as wireless telephony, word processing, spreadsheets, and so forth. In other words, for advanced models, there are increasing cross over or convergent of the functionalities.

Much of these functionalities are designed to increase the productivity of business users. Lately, some manufacturers have begun to include functionalities, such as games, instant/text messaging, radio, music player, and so forth, designed for the more youthful users. Few functions, if any, have been introduced for the elder users, which in the U.S., is rapidly becoming the largest user segment, as the baby boomer generation reaching the retirement age.

Thus, it is desirable to enhance mobile communication devices with functionalities designed for the older users. In particular, it is desirable to enhance mobile communication devices with a function to verify a user's wellness under various conditions, as many of the older users are without company or otherwise unattended to often.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a mobile communication device, more specifically, a wireless mobile phone, incorporated with the teachings of the present invention, in accordance with one embodiment;

FIG. 2 illustrates an architectural view of the wireless mobile phone of FIG. 1, in accordance with one embodiment;

FIG. 3 illustrates the operational flow of the relevant aspects of the user wellness verification function of FIG. 2, in accordance with one embodiment;

FIG. 4 illustrates an exposed view of the wireless mobile phone of FIG. 1, including a back view of an interchangeable cover where the teachings of the present invention are incorporated, in accordance with an alternate embodiment;

FIGS. 5-6 illustrate two variants of another wireless mobile phone, incorporated with the teachings of the present invention, in accordance with two other alternate embodiments;

FIGS. 7a-7c illustrate yet another wireless mobile phone, incorporated with the teachings of the present invention, in accordance with yet another alternate embodiment; and

FIGS. 8a-8d illustrate a number of exemplary instructions to verify user wellness, in accordance with a number of embodiments.

### DETAILED DESCRIPTION OF EMBODIMENTS OF THE INVENTION

The present invention includes a mobile communication device, in particular, in some embodiments, an interchangeable cover of the device, equipped to verify wellness of a user of the device under various conditions.

Parts of the description will be presented in terms, such as mobile communication devices, wireless mobile phones, interchangeable covers, and so forth, consistent with the manner commonly employed by those skilled in the art to convey the substance of their work to others skilled in the art.

As well understood by those skilled in the art, the term “mobile communication device” as used herein (hereafter, simply “mobile device”), including in the claims, comprise wireless mobile phones, PDA, and other devices of the like.

The term “wireless mobile phone” as used herein (in the specification and in the claims) refers to the class of telephone devices equipped to enable a user to make and receive calls wirelessly, notwithstanding the user's movement, as long as the user is within the communication reach of a service or base station of a wireless network service provider. Unless specifically excluded, the term “wireless mobile phone” is to include the analog subclass as well as the digital subclass (of all signaling protocols).

The term “cover” as used herein refers to a part that inherently includes multiple surfaces that cover at least multiple ones of the exterior surfaces of the body or core unit of a mobile device, where the exterior surfaces are inherently disposed in different geometric planes. Accordingly, while a “cover” may come in many variants, as illustrated by the description to follow, a “card” like part, i.e. a part having the form factor of a “credit card”, a PCMCIA card, a PC card, a Compact Flash card and so forth, is not a “cover”, for the purpose of the present application. A “card” like part, for the purpose of the present application, by definition, is considered to occupy only one geometric plane. [PCMCIA=Personal Computer Memory Card International Association] In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will be apparent to one skilled in the art that the present invention may be practiced without the specific details. In other instances, well-known features are omitted or simplified in order not to obscure the present invention.

Various operations will be described as multiple discrete steps in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may.

The terms “comprising “having” and “including” are synonymous, unless the context dictates otherwise.

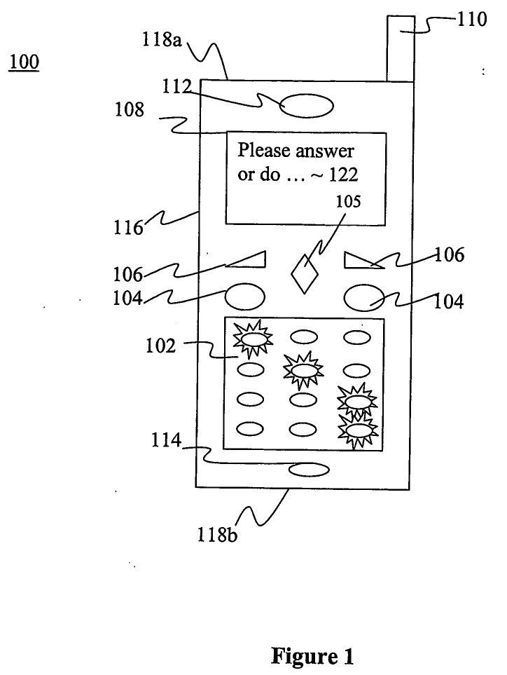

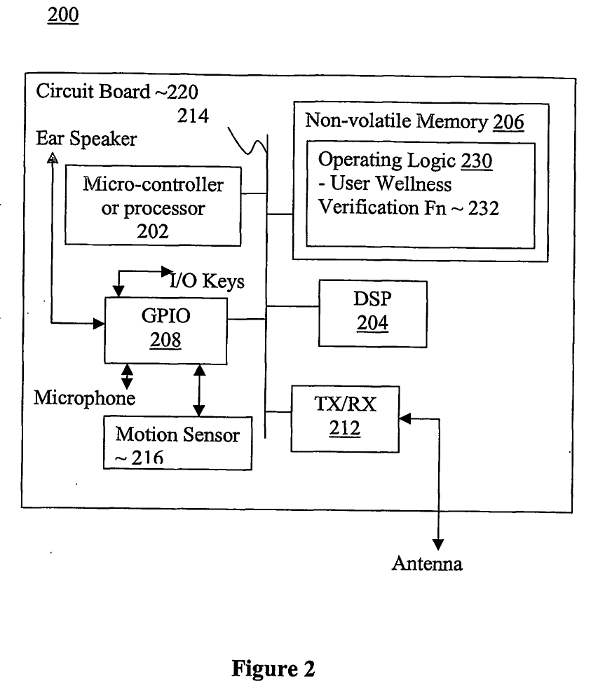

Referring now to FIGS. 1-2, wherein a front view and an internal component view of a wireless mobile phone 100, incorporated with the teachings of the present invention, in accordance with one embodiment, is shown. As illustrated in FIG. 2, operating logic 230 of wireless mobile phone 100 includes in particular, a user wellness verification function 232 equipped with logic to verify the wellness of a user of phone 100 under various conditions, referred to as user wellness verification conditions, to be described more fully below. For the embodiment, phone 100 also includes an optional motion sensor 216, such as, an accelerometer, to sense motion of phone 100 and provide the sensing results for identification of some of the user wellness conditions.

Beside novel user wellness verification function 232 and motion sensor (e.g. accelerometer) 216, phone 100 includes conventional elements such as body casing 116, display 108, standard input key pad 102 having a number of conventional alphanumeric keys, “talk” and “end talk” buttons 104, scroll button 105, selection buttons 106, antenna 110, ear speaker 112, and microphone 114. In various embodiments, keys of key pad 102 are either surrounded by or otherwise include illuminable light emitting diodes (LED) in their background. The terms “button” and “key” are synonymous, unless the context clearly indicates otherwise.

Internally, phone 100 includes conventional elements, such as micro-controller/processor 202, digital signal processor (DSP) 204, non-volatile memory 206, general purpose input/output (GPIO) interface 208, transmit/receive (TX/RX) 212 (also known as transceiver), and battery power (not shown) coupled to each other via bus 214 and disposed on a circuit board 220.

Except for user wellness verification function 232, optional motion sensor 216, and the employment of some of the enumerated elements in novel manners to practice the present invention, the enumerated elements otherwise perform their conventional functions known in the art.

Non-volatile memory 206 is employed to store programming instructions and optionally, working data, including operating logic 230 with user wellness verification function 232. Working data may include the designated party or parties (e.g. their phone numbers or IP addresses) to whom user wellness verification function 232 is to report, in the event the user of phone 100 fails to confirm wellness when requested. Working data may also include the constant portion of the substance of the report (e.g. the constant portion of the voice/text message). An example of a constant portion of a voice/text message is “Hello, please be advised that <user name> may not be well.” As the previous sentences suggest, reporting may be in the form of a call or a text message, or other communications of like kind.

Processor 202, assisted by DSP 204, is employed to operate phone 100, executing operating logic 230, including user wellness verification function 232. Beside user wellness verification function 232, operating logic 230 is equipped to facilitate and track usage of phone 100. In some embodiments, usage may include voice calls as well as text messaging. For text messaging, messages may be sent in the format of Short Messaging Service (SMS), Hypertext Transport Protocol (HTTP) or other format/protocol of the like.

Battery power (not shown) provides power for the various enumerated components, including indication of remaining power.

Motion sensor 216, when included, may be employed to denote motion, including change in altitude.

Keys of key pad 102 may be employed to enter alphanumeric data, including entering a sequence of alphanumeric data as requested to verify a user's wellness.

Scroll key 105 and companion selection keys 106 may be employed to scroll and select various options or list items of various menu options or selection lists, including scrolling and selecting list items presented for user interactions to verify the user's wellness. For the embodiment, scroll key 105 may be selected in one of two positions, an “up” position or a “down” position for scrolling a selection list in an “up” direction and a “down” direction respectively.

GPIO 208 may be employed to generate input signals, such as a corresponding “alphanumeric” signal in response to a user selection of one of the keys of key pad 102, a “scroll” signal (or more specifically, a “scroll up” or a “scroll down” signals) in response to a user selection of scroll key 105, a “selection” signal in response to a user selection of select button 106, and so forth.

TX/RX 212 may be employed to transmit and receive signals for a call and/or a text message, including in particular, a call placed or a text message sent by user wellness verification function 232 when a user fails to confirm his/her wellness. TX/IRX 212 may support one or more of any of the known signaling protocols, including but are not limited to CDMA, TDMA, GSM, and so forth.

The constitutions of these elements are known, and will not be further described. As to user wellness verification function 232, it may be implemented in the assembly or machine instructions of processor 202, or a high level language that can be compiled into these assembly or machine languages.

Accordingly, except for the enhancements provided, phone 100 otherwise represents a broad range of wireless mobile phones, including both the analog as well as the digital types (of all signaling protocols), substantially rectangular uni-body as illustrated, or curved uni-body, as well as multi-portions, such as “flip phones” to be illustrated later.

Further, while the present invention will be described primarily referencing wireless mobile phone 100 of FIG. 1, and other alternate embodiments, referencing the remaining figures, the present invention is not so limited. The present invention may be practiced with PDA incorporated with telephony modules, or facilities, and other devices of the like. These devices are all within the anticipated scopes of the present invention.

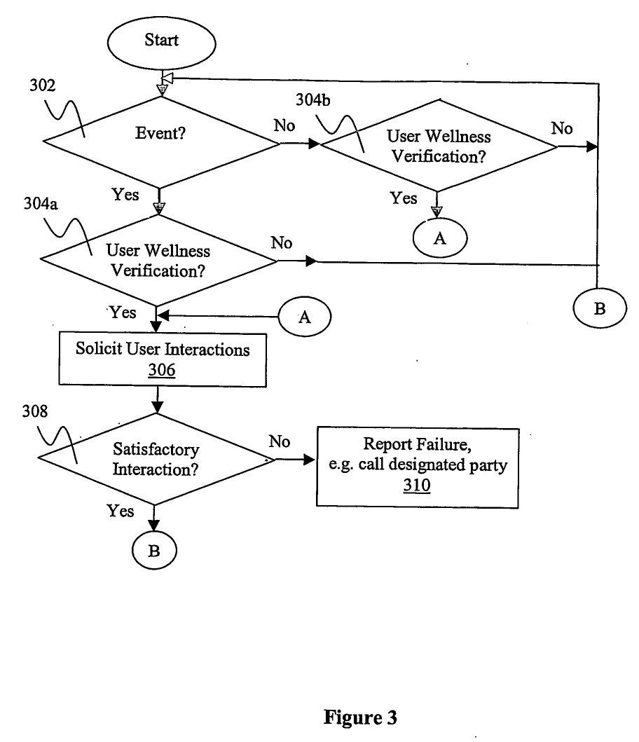

FIG. 3 illustrates the operational flow of the relevant aspects of user wellness verification function 232, in accordance with one embodiment. As illustrated, on start up/reset, user wellness verification function 232 (hereinafter, simply verification function) monitors for occurrence of various events within phone 100, block 302. On either detection of an event being reported, or periodically, between reporting of events, verification function 232 determines whether the reporting of an event, or the absence of reporting of event denotes a user verification condition, blocks 304a-304b.

In one embodiment, the user wellness verification conditions due to the reporting of an event may include a) battery power of phone 100, as reported by battery power, has dropped beneath a “floor” threshold, and

b) phone 100, as reported by motion sensor (e.g. accelerometer) 216, has experienced a change in vertical altitude in excess of a change rate threshold (potentially, because the user fell).

In one embodiment, the user wellness verification conditions due to the absence of reporting of event may include

a) phone 100, as indicated by the absence of motion reporting by motion sensor (e.g. accelerometer) 216, has not been moved for a period of time, and

b) phone 100, as indicated by the absence of usage reporting by operating logic 230, has not been used for a period of time.

In alternate embodiments, the user wellness verification conditions may include more or less conditions.

On determining that the reporting of an event or the absence of reporting of event does not denote a user wellness verification condition, the process continues back at block 302.

However, if the reporting of an event or the absence of reporting of event is determined to denote a user wellness verification condition, verification function 232 solicits user interactions with phone 100 to verify the user is well, block 306.

In one embodiment, depending on the user wellness verification condition that prompted the user wellness verification, the user interaction solicited may include e.g.

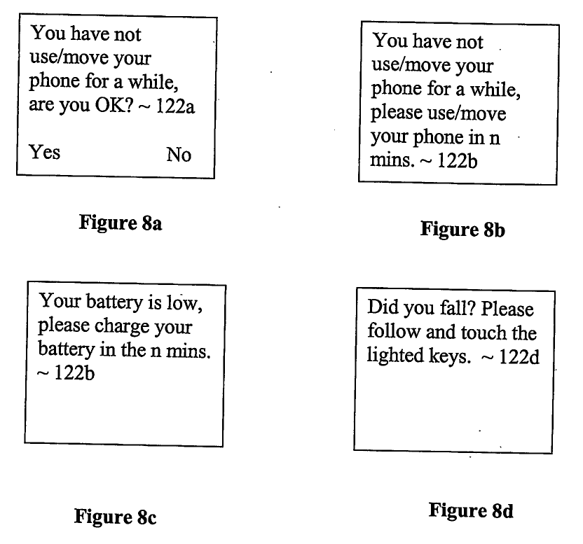

a) move or use phone 100 “immediately”, i.e. within a relatively short prescribed time (FIG. 8b),

b) charge phone 100 “immediately”, i.e. within a relatively short prescribed time (FIG. 8b),

c) answer one or more prompts or questions (FIG. 8a), and

d) follow one or more instructions, e.g. touching one or more keys as instructed (FIG. 8d).

In one embodiment with illuminable LED underneath or surrounding input keys of key pad 102, for interaction type (d), the keys to be touched may be illuminated successively, identifying the keys the user to touch in sequence.

In alternate embodiments, other user interactions may be solicited instead. In one embodiment, verification function 232 alerts or otherwise attempts to get the attention of the user to verify his/her wellness, by simulating the receipt of a call, which may include causing a series of rings, vibrations, and so forth.

If the user fails to verify his/her wellness to the “satisfaction” of verification function 232, verification function 232 reports the failure, block 310. As described earlier, the reporting may be in the form of one or more voice calls or text messages or other communications of like kind to one or more designated parties. The designated party or parties may be a member of the user's immediate family, a member of the user's extended family (i.e. relative), a business associate, a health care provider (a nurse, a doctor or their assistant), a messaging service, and so forth. The names of the parties, the manner of reporting, and any information needed to make the reporting, e.g. phone numbers, IP addresses may be provided to phone 100 via any one of a number of known configuration means or to be designed. For examples, the information may be entered by the user, downloaded (e.g. at the time of signing up for the service, assuming the invention is offered as a service), or pre-loaded at the factory (if the function is an integrated offering of the network service provider), and so forth. Similarly, the provided information may be stored in any one of a number of known data organizations or to be designed

What constitutes “satisfactory” verification is application dependent. For example, if the verification involves having the user answer a prompt, then answering the prompt correctly may constitute “satisfactory” verification. On the other hand, if the verification involves answering a series of questions, then answering n of m questions correctly, n and m being integers, may constitute “satisfactory” verification.

If the verification involves performing a task, such as moving or using the phone, or touching a sequence of keys within m minutes, then moving or using the phone, or touching the sequence of keys within the prescribed time, may constitute “satisfactory” verification. In the case of touching a sequence of keys, the additional requirement of touching p of q keys correctly, p and q being integers, may also be included in the “satisfactory” determination.

If the user verifies his/her wellness to the “satisfaction” of verification function 232, the process returns to block 302, and continues from there as earlier described.

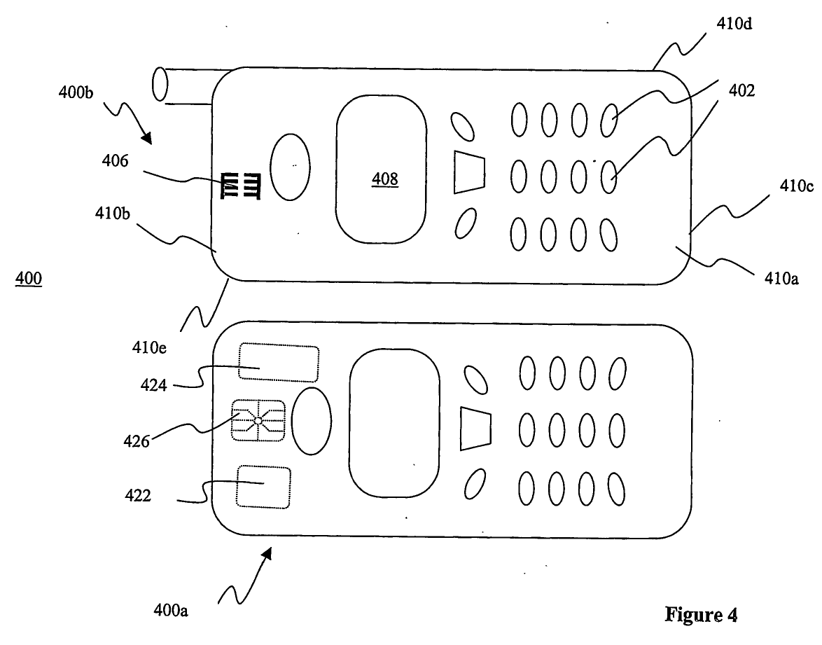

FIG. 4 illustrates an exposed view of a phone 400, incorporated with the teachings of the present invention, in accordance with an alternate embodiment. For the embodiment, unlike the embodiment of FIG. 1, user wellness verification function 232, including optional motion sensor 216, are embedded in interchangeable cover 400a of phone 400. Cover 400a is designed to mate with core unit 400b of phone 400 covering front surface 400a and the side surfaces 400b-400e.

More specifically, all or portion of user wellness verification function 232 is embedded in electronic component 422. In the case of partial embodiment of user wellness verification function 232, electronic component 422 may include data, such as a uniform resource locator (URL), identifying one or more remote locations from where the “remainder” of user wellness verification function 232 may be obtained. Of course, “remainder” may be the entire user wellness verification function 232. That is, electronic component 422 includes only data such as a uniform resource locator (URL), identifying one or more remote locations from where the entire user wellness verification function 232 may be obtained.

User wellness verification function 232 (in whole or in part) or data identifying the remote location(s) where user wellness verification function 232 is located (in whole or in part), as well as output signals of motion sensor 424 may be provided to the core components within core body 400b of phone 400 via complementary contacts 406 and 426.

Of course, in yet other embodiments, either user wellness verification function 232 or motion sensor 216 may be disposed on an interchangeable cover, and not both.

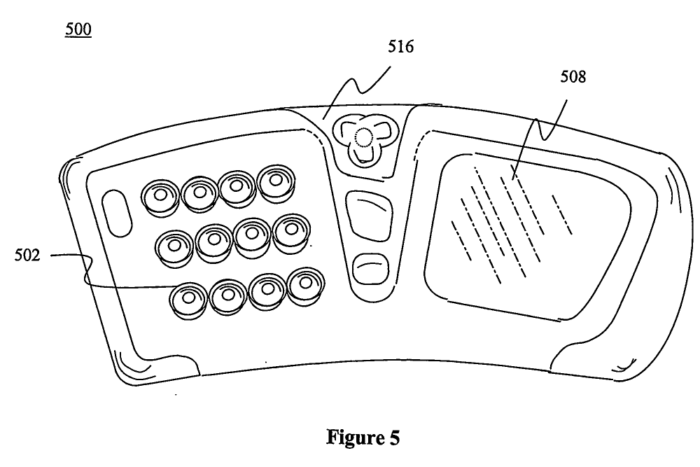

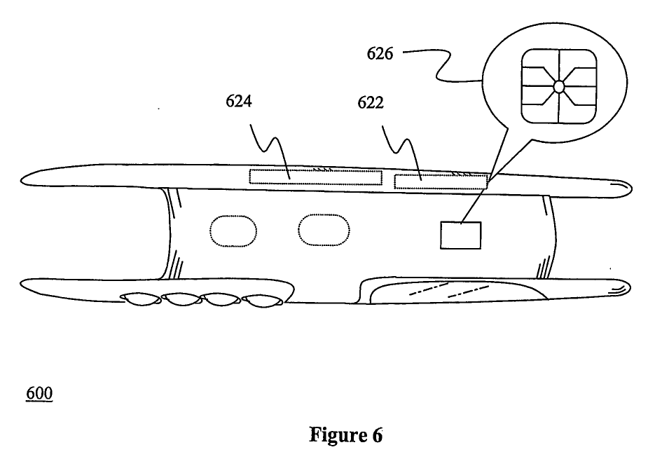

FIGS. 5-6 illustrate yet two other embodiments incorporated with the teachings of the present invention. FIG. 5 illustrates an alternate embodiment where the earlier described user wellness verification function, including optional motion sensor, are disposed inside core unit 516 of phone 500 as the embodiment of FIG. 1. The two embodiments differ only in that phones 100 and 400 are substantially rectangular in shapes, whereas phone 500 has a curved shape. Further, for phones 100 and 400, input keys 102 and 402 are disposed “underneath” display 108 and 408 respectively, whereas for phone 500, it is the opposite. That is, input keys 502 are disposed “above” display 508.

Note that since both input keys 1021502 and displays 108/508 have their natural orientations, i.e. the manner they are designed to be read, thus the “beneath”/“above” relative disposition is objectively determined.

FIG. 6 illustrates an alternate variation of FIG. 5, similar to FIG. 4 as an alternate variation of FIG. 1. That is, the user wellness verification function (in whole or in part) is disposed in an electronic component 622, which along with optional motion sensor 624, are embedded in interchangeable cover 600. The verification function (in whole or in part) or the data identifying where the verification function may be obtained (in whole or in part), as well as the output signals of motion sensor 624 are provided to the core components of a phone against which cover 600 is attached, via contact 626 and its counterpart.

As described earlier, in yet other embodiments, either user wellness verification function 232 or motion sensor 216 may be disposed on an interchangeable cover, and not both.

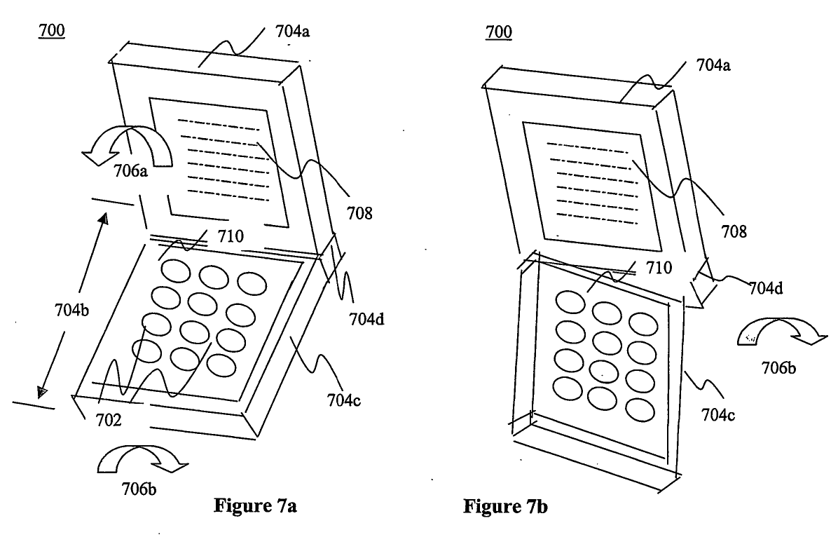

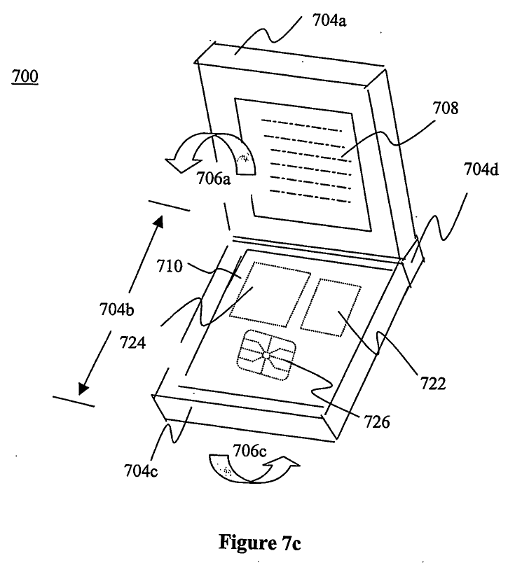

FIGS. 7a-7c illustrate yet another embodiment of the present invention. More specifically, Fig, 7a-7c illustrate three mated views of a mobile phone 700 having a core unit and cover 710, endowed with the teachings of the present invention. Unlike the earlier described embodiments, the core unit of mobile phone 700 has a multi-section form factor comprising a first section 704a and a second section 704b, and the second section 704b is further comprised of at least two sub-sections 704c-704d. The first and second sections 704a-704b may pivot towards each other as denoted by direction arrow 706a or away from each other opposite to the direction denoted by arrow 706a. Sub-section 704c may rotate relative to sub-section 704d as denoted by the directions denoted by arrows 706b-706c. In other words, phone 700 may be considered as an improved version of what is commonly referred to as “flip” phones.

Similar to the earlier described embodiments, the core unit of mobile phone 700 includes in particular, display 708, a number of input keys 702, and an expansion interface (covered by cover 710), and internal components similar to those of FIG. 2. As described earlier, section 704b of phone 700 with which cover 710 is to mate, includes a front and a number of side and end exteriors surfaces, disposed in different geometric planes.

Cover 710 is of a type similar to cover 600 of FIG. 6, i.e. U-shaped, except electronic components 722-724 and contact 726 are disposed on the inside surface of the “back” surface of cover 710. As before, upon mating with sub-section 704c of phone 700, cover 710 covers at least partially a front surface and one of the side and end surfaces of sub-section 704c.

As described earlier, in yet other embodiments, either user wellness verification function 232 or motion sensor 216 may be disposed on an interchangeable cover, and not both.

Conclusion and Epilogue

Thus, it can be seen from the above descriptions, a novel mobile device equipped with a function to verify wellness of a user of the device under various conditions has been described.

While the present invention has been described in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A mobile communication device comprising
one or more components to report on one or more events to contribute to identification of a user wellness verification condition; and
logic operatively coupled to the components to monitor and receive said reporting, to identify user wellness verification conditions based at least in part on said reporting or absence of said reporting, and to solicit, in response to each identification, a user of the mobile communication device to verify wellness of the user.

2. The mobile communication device of claim 1, wherein said one or more components are equipped to report a low battery condition, and said logic is equipped to monitor the reporting of a low battery condition, identify the reporting as a user wellness verification condition, and solicit the user to charge the device within a required time period.

3. The mobile communication device of claim 1, wherein said one or more components are equipped to report idleness the mobile communication device, and said logic is equipped to monitor the reporting, identify the idleness as a user wellness verification condition when the idleness becomes excessive, and solicit the user to use the device within a required time period.

4. The mobile communication device of claim 1, wherein said one or more components comprise a motion sensor to sense and report on motion of the mobile communication device, and said logic is equipped to identify at least a selected one of the mobile communication device having been stationery for a period, and the mobile communication device having experienced a rapid change in altitude in excess of a change rate threshold.

5. The mobile communication device of claim 1, wherein said logic is equipped to cause the mobile communication device to simulate receipt of a call to attempt to get the user's attention, on identifying a user wellness verification condition.

6. The mobile communication device of claim 1, wherein said logic is equipped to solicit the user, in response to an identification of a user wellness verification condition, to follow one or more instructions to demonstrate the user is well.

7. The mobile communication device of claim 1, wherein said logic is equipped to solicit the user, in response to an identification of a user wellness verification condition, to perform at least a selected one of answering a prompt and touch one or more keys to demonstrate that the user is well.

8. The mobile communication device of claim 1, wherein said logic is further equipped to report, on failure of the user to satisfactorily interact with the mobile communication device as solicited, the failure.

9. The mobile communication device of claim 8, wherein said logic is equipped to perform at least a selected of placing a call and sending a text message to a designated party, in response to the user failing to satisfactorily interact with the mobile communication device as solicited.

10. The mobile communication device of 9, wherein the designated party is a party selected the party group consisting of a message service, a health care provider, a family member, and a relative.

11. The mobile communication device of claim 1, wherein the mobile communication device is a mobile communication device selected from the communication device group consisting of a wireless mobile phone, and a personal digital assistant equipped with communication capabilities.

12. A interchangeable cover for mobile communication device comprising:
a cover body; and
one or more components embedded in the cover body having at least a selected one of data and logic to at least contribute to enabling the mobile communication device to monitor and receive reporting of events, to identify user wellness verification conditions based at least in part on said reporting or absence of said reporting, and to solicit, in response to each identification, a user of the mobile communication device to verify wellness of the user.

13. The interchangeable cover of claim 12, wherein said at least a selected one of data and logic is equipped to at least contribute to causing the mobile communication device to simulate receipt of a call to attempt to get the user's attention, on identifying a user wellness verification condition.

14. The interchangeable cover of claim 12, wherein said at least a selected one of data and logic is equipped to at least contribute to solicit the user, in response to an identification of a user wellness verification condition, to follow one or more instructions to demonstrate the user is well.

15. The interchangeable cover of claim 12, wherein said at least a selected one of data and logic is equipped to at least contribute to solicit the user, in response to an identification of a user wellness verification condition, to perform at least a selected one of answering a prompt and touch one or more keys to demonstrate that the user is well.

16. The interchangeable cover of claim 12, wherein said at least a selected one of data and logic is further equipped to report, on failure of the user to satisfactorily interact with the mobile communication device as solicited, the failure.

17. The interchangeable cover of claim 16, wherein said at least a selected one of data and logic is equipped to at least contribute to performing at least a selected of placing a call and sending a text message to a designated party, in response to the user failing to satisfactorily interact with the mobile communication device as solicited.

18. The interchangeable cover of claim 17, wherein the designated party is a selected one of a message service, a health care provider, a family member, and a relative.

19. The interchangeable cover of claim 12, wherein said one or more components further comprise a motion sensor to sense and report on motion of the mobile communication device, and said at least a selected one of data and logic is equipped to at least contribute to identify at least a selected one of the mobile communication device having been stationery for a period, and the mobile communication device having experienced a rapid change in altitude in excess of a change rate threshold.

20. The interchangeable cover of claim 12, wherein the cover body is U-shaped and designed to be attached to the mobile communication device from a side of the mobile communication device.

21. The interchangeable cover of claim 12, wherein the interchangeable cover is a front cover plate, with the cover body designed to be attached to the mobile communication device from a front of the mobile communication device.

22. The interchangeable cover of claim 12, wherein the interchangeable cover is a back cover plate, with the cover body designed to be attached to the mobile communication device from a back of the mobile communication device.
